(19) United States
(12) Patent Application Publication
(10) Pub. No.: US 2025/0078144 A1
(43) Pub. Date: Mar. 6, 2025

(54) TERMINAL, DISPLAY SYSTEM AND DISPLAY METHOD

(71) Applicant: TOYOTA JIDOSHA KABUSHIKI KAISHA, Toyota-shi (JP)

(72) Inventor: Tomoe NAGASAWA, Tokyo (JP)

(73) Assignee: TOYOTA JIDOSHA KABUSHIKI KAISHA, Toyota-shi (JP)

(21) Appl. No.: 18/772,955

(22) Filed: Jul. 15, 2024

(30) Foreign Application Priority Data
Sep. 4, 2023 (JP) 2023-142795

(51) Int. Cl. G06Q 30/0601; G06F 3/0482; G06F 3/0488

(52) U.S. Cl. CPC G06Q 30/0641; G06F 3/0482; G06F 3/0488

(57) ABSTRACT

A terminal includes a display device configured to display a grade of a product and an option of the product, an input device configured to receive an operation for selecting the grade and an operation for selecting the option, and a control device configured to control the display device to display price information of the product in a state in which the grade and the option are selected. The grade includes a first grade and a second grade. The control device is configured to, in a state in which the first grade and the option are selected, when the input device receives an operation for changing grade selection from the first grade to the second grade, update a display of the price information to a display of the price information corresponding to the second grade while maintaining a selected state of the option selected in the first grade.

### CROSS-REFERENCE TO RELATED APPLICATION

This application claims priority to Japanese Patent Application No. 2023-142795 filed on Sep. 4, 2023, incorporated herein by reference in its entirety.

### BACKGROUND

### 1. Technical Field

The present disclosure relates to a terminal, a display system, and a display method for a product selection operation.

### 2. Description of Related Art

For example, Japanese Unexamined Patent Application Publication No. 2020-035164 (JP 2020-035164 A) discloses a technique in which, when a prospective purchaser of a vehicle performs operations for purchasing a vehicle using a terminal, one or more grades that are equipped with or can be equipped with main equipment selected by the prospective purchaser of the vehicle are identified, and the identified vehicle models are displayed on the terminal.

### SUMMARY

However, in selecting a product such as a vehicle using a terminal, when an operation is performed to change only the grade of the product in a state in which the grade and options of the product are selected, the selection state of the options may be changed to the initial state (unselected state), so that the purchaser will be asked to reselect options for the changed grade. Therefore, the product selection operation becomes troublesome, and there is room for improvement.

The present disclosure provides a terminal, a display system, and a display method that facilitate a product selection operation.

According to an aspect of the present disclosure, a terminal includes: a display device configured to display a grade of a product and an option of the product; an input device configured to receive an operation for selecting the grade and an operation for selecting the option; and a control device configured to control the display device to display price information of the product in a state in which the grade and the option are selected. The grade includes a first grade and a second grade, the control device is configured to, in a state in which the first grade and the option are selected, when the input device receives an operation for changing grade selection from the first grade to the second grade, update a display of the price information to a display of the price information corresponding to the second grade while maintaining a selected state of the option selected in the first grade.

With this configuration, since the selected state of the option is maintained even after the operation for changing the grade of the product is performed, a user does not have to reselect the option and can check the price of the grade after change using the display of the updated price information. Therefore, the product selection operation can be facilitated.

In the above aspect, the control device may be configured to, when the input device receives the operation for changing the grade selection from the first grade to the second grade, maintain the selected state of the option that is selectable in the second grade out of the options selected in the first grade.

With this configuration, since the selected state of selectable option in the grade after the change is maintained, the user does not have to reselect the option. Therefore, the product selection operation can be facilitated.

Furthermore, in the above aspect, the control device may be configured to, in the state in which the first grade and the option are selected, display an image of the product corresponding to the selected first grade and the selected option on the display device. The control device may be configured to, when the input device receives the operation for changing the grade selection from the first grade to the second grade, update the image of the product corresponding to the first grade and the selected option to an image of the product corresponding to the second grade and the selected option.

With this configuration, since the image of the product is updated to that corresponding to the option selected after the operation of changing the grade is performed and the changed grade, the user can check the appearance of the product.

Furthermore, in the above aspect, the option may include at least one of an exterior color of the product, a function that is selectably provided in the product, and a function group that is a combination of a plurality of kinds of functions.

With this configuration, for example, since the grade is changed while the display of the option including the selected exterior color is maintained, the user can easily check the appearance and price information for the changed grade.

Furthermore, in the above aspect, the input device may include a touch panel. The control device may be configured to select the grade by receiving a contact operation in a first direction on the touch panel, and display at least one of a plurality of the options by receiving a contact operation in a second direction orthogonal to the first direction on the touch panel.

With this configuration, since the grade and the option can be selected depending on the direction of the contact operation on the touch panel, the user can select the grade of the product and the option with an easy operation.

Furthermore, in the above aspect, information included in the grade of the product may be at least one of a fuel type, a capacity, a drive system, a displacement, and a popularity level.

Additionally, in the above aspect, the product may include a vehicle.

With this configuration, the user can select the grade of the vehicle and the option with an easy operation.

According to another aspect of the present disclosure, a display system includes a server and a terminal configured to communicate with the server. The terminal includes a display device configured to display a grade of a product and an option of the product, an input device configured to receive an operation for selecting the grade and an operation for selecting the option, and a control device configured to control the display device to display price information of the product in a state in which the grade and the option are selected. The grade includes a first grade and a second grade. The control device is configured to, in a state in which the first grade and the option are selected, when the input device receives an operation for changing grade selection from the first grade to the second grade, generate the price information corresponding to the second grade using information received from the server and update a display of the price information to a display of the generated price information while maintaining a selected state of the option selected in the first grade.

According to yet another aspect of the present disclosure, a display method displays price information of a product on a display by a control device. The display method executed by the control device includes: receiving an operation for selecting a grade of the product and an operation for selecting an option of the product; displaying on the display the price information of the product in a state in which the grade and the option are selected; and in a state in which the first grade and the option are selected, when an operation for changing grade selection from a first grade to a second grade is received, updating a display of the price information to a display of the price information corresponding to the second grade while maintaining a selected state of the option selected in the first grade. In the display method, the first grade and the second grade are included in the grade.

According to the present disclosure, it is possible to provide a terminal, a display system, and a display method that facilitate a product selection operation.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram schematically showing an example of an overall configuration of a display system;

FIG. 2 is a diagram showing an example of a configuration of a terminal;

FIG. 3 is a diagram showing an example of a display screen displaying an estimated amount of a monthly usage fee when a vehicle is used under a subscription system;

FIG. 4 is a flowchart illustrating an example of a process executed by a control unit of the terminal;

FIG. 5 is a diagram for explaining an example of a change in the display screen when a swipe operation is performed; and

FIG. 6 is a diagram illustrating an example of the display screen displaying an estimated amount of the monthly usage fee after a grade has been changed.

### DETAILED DESCRIPTION OF EMBODIMENTS

Hereinafter, an embodiment of the present disclosure will be described in detail with reference to the drawings. In the drawings, the same or corresponding portions are denoted by the same reference signs and the description thereof will not be repeated.

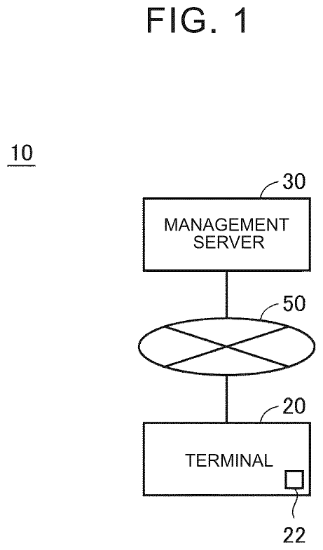

FIG. 1 is a diagram schematically showing an example of an overall configuration of a display system 10. Referring to FIG. 1, a display system 10 includes a terminal 20 and a management server 30. The terminal 20 and the management server 30 are configured to be able to communicate with each other via a communication network 50 such as the Internet.

The terminal 20 is a computer owned by a user who desires to use a vehicle (hereinafter referred to as the user) that is a product in the present embodiment, and may be a mobile terminal such as a smartphone or a tablet. The terminal 20 includes a touch panel display 22 in addition to a control unit, a storage unit, and a communication unit that will be described later.

The management server 30 is a computer that manages information (more specifically, price information) about vehicles to be used. The vehicles include, but are not particularly limited to, electrified vehicles such as battery electric vehicles and hybrid electric vehicles that use a motor as a drive source, and vehicles that use an engine as a drive source.

The management server 30 includes a control unit, a communication unit, and a storage unit (all not shown). The control unit includes, for example, a central processing unit (CPU) and memories (read only memory (ROM) and random access memory (RAM)). The communication unit is configured to be able to communicate with the communication unit of the terminal 20 via the communication network 50. The storage unit stores the above information about the vehicles to be used. The control unit executes various processes based on information acquired from the communication unit and the storage unit, and information such as maps and programs stored in the memories.

For example, the user performs an operation for selecting a vehicle on the terminal 20 and a definitive process (for example, payment processing, etc.) is performed for the selected vehicle as a vehicle to be used. After that, the vehicle to be used is delivered to the user and, alternatively, the user visits a store, such as a dealer, that handles the vehicle to be used. The user can thus use the vehicle.

More specifically, in the present embodiment, it is assumed that the use of the vehicle includes the use of the vehicle under a subscription system in which the vehicle can be used by paying a monthly usage fee. In the terminal 20, for example, when a predetermined installed application for enabling the use of the vehicle under a subscription system is started, the user operates selection items, images, etc. displayed on the display screen, thereby selecting a vehicle model, a grade, and options of the vehicle that the user desires to use. In the present embodiment, a case will be described as an example in which an estimated amount of a monthly usage fee corresponding to the selected vehicle model, grade, and options is displayed on the display screen of the application. Note that when the user accepts the estimated amount, the user performs an operation to enter into a predetermined usage contract, and thus the user can use the vehicle.

The management server 30 stores price information about vehicle models, options, and grades of the vehicle to be used. More specifically, the management server 30 stores price information including the base amount of the monthly usage fee for each grade of each vehicle model and the extra fee for each option. The management server 30 transmits the above price information to the terminal 20, for example, every time a predetermined period elapses, or transmits, in response to a request from the terminal 20, the price information to the requesting terminal 20.

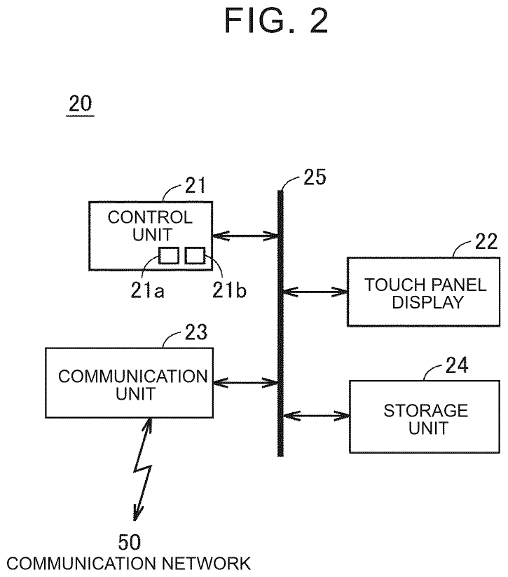

FIG. 2 is a diagram showing an example of a configuration of the terminal 20. Referring to FIG. 2, the terminal 20 includes a control unit 21, a touch panel display 22, a communication unit 23, a storage unit 24, and a communication bus 25.

The control unit 21 includes, for example, a CPU and memories (ROM and RAM). The control unit 21 executes various processes based on information acquired from the communication unit 23 and the storage unit 24 and information such as maps and programs stored in the memories to control a display device of the touch panel display 22 and the like.

The touch panel display 22 includes the display device including a display screen and an input device constituted by a touch panel.

When a user's contact operation on the touch panel is received, a signal corresponding to the received contact operation (for example, a signal indicating a contact position) is transmitted to the control unit 21 via the communication bus 25. The display device of the touch panel display 22 displays an image corresponding to a control signal received from the control unit 21 via the communication bus 25.

The communication unit 23 is configured to be able to communicate bidirectionally with the management server 30 via the communication network 50. The communication unit 23 is configured to enable wireless communication with a wireless base station connected to the communication network 50, for example. The terminal 20 and the wireless base station may be connected to enable wireless communication via a mobile phone line, for example, or may be connected to enable wireless communication via Wi-Fi and the like.

The storage unit 24 stores, for example, information about the vehicle models, grades, and options of the vehicle. Specifically, the storage unit 24 stores selectable grades for a certain vehicle model, selectable options for each grade, and base fee information about the base amount of the monthly usage fee of the vehicle for each grade, and extra fee information about the extra fee for each option.

In the display system 10 having the above configuration, for example, the user starts an application on the terminal 20 and performs an operation on the application to select a vehicle model of the vehicle that the user desires to use. Furthermore, the user performs an operation for selecting a desired grade of the selected vehicle model. Furthermore, the user performs an operation for selecting desired options of the selected grade. The terminal 20 causes the display device of the touch panel display 22 to display the price information (the estimated amount of the monthly usage fee) corresponding to the selected vehicle model, the selected grade, and the selected options. This allows the user to check the estimated amount of the monthly usage fee for the vehicle he or she desires to use.

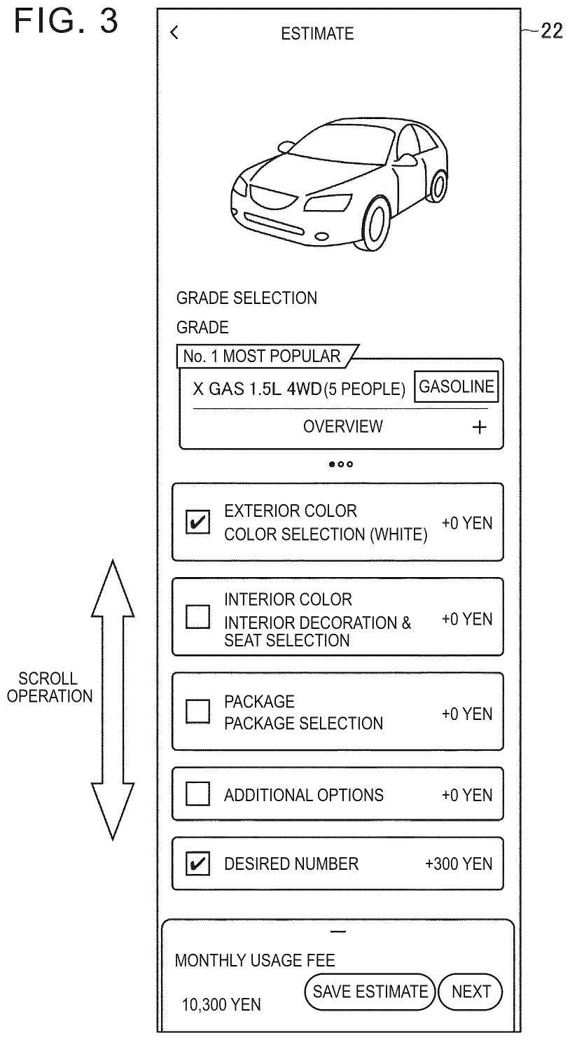

FIG. 3 is a diagram showing an example of the display screen displaying an estimated amount of a monthly usage fee when a vehicle is used under a subscription system. As shown in FIG. 3, the screen of the display device of the touch panel display 22 displays an image of the vehicle of a vehicle model and a grade that are selected by the user, various types of information about the selected grade (hereinafter referred to as the grade selection information), various types of information about selected options (hereinafter referred to as the option selection information), and the estimated amount of the monthly usage fee.

The grade selection information includes, for example, text information of the selected grade, as well as text information such as fuel type, capacity, drive system, engine displacement, popularity level, and the like. In FIG. 3, for example, inside a rectangular frame, the following text information is displayed: text information “X” indicating the grade, text information “GAS” indicating that the fuel is gasoline, text information “1.5 L” indicating that the displacement is 1.5 L, text information “4WD” indicating that the drive system is four-wheel drive, and text information “5 people” indicating that the capacity is five people. Furthermore, in FIG. 3, text information “No. 1 most popular” indicating the level of popularity is displayed at the top left of the rectangular frame.

Similarly, the option selection information includes text information about multiple option items, checkboxes for respective option items, and text information about an extra fee depending on whether each option item is selected. A checkbox with a check mark shows that an option corresponding to the checkbox is in a selected state. Examples of the option items include, but are not limited to, an exterior color item, an interior color item, a package item in which multiple types of options are combined, an additional option item including other various discrete options, and a desired number item indicating an option for obtaining a user-desired number for a license plate.

A rectangular frame is set for each option, and the option items are arranged in the longitudinal direction of the display screen. Inside the rectangular frame, a checkbox, text information indicating the option item, text information indicating supplementary information such as the selected color, and text information indicating the extra fee for the option alone are displayed.

When the user performs a contact operation in the longitudinal direction (hereinafter referred to as a scroll operation) on the touch panel, at least one of the options is displayed. For example, when the display of the rectangular frames for the respective option items does not fit within the display screen, a scroll operation will cause displayed option items out of the option items to be hidden, and hidden option items to be displayed. That is, the user performs a scroll operation, and thus the user can select each of the option items.

When the user performs a touch operation on the position of the checkbox in the rectangular frame, a checkmark is displayed in the checkbox, and the option item corresponding to the checkbox is in the selected state.

FIG. 3 shows a state in which a check mark is displayed in the checkbox corresponding to the exterior color item. Furthermore, FIG. 3 shows that white is selected as the exterior color and that the extra fee is zero yen.

Furthermore, FIG. 3 shows a state in which a check mark is displayed in the checkbox corresponding to the desired number item. Furthermore, FIG. 3 shows that the option of the desired number is selected and that the extra fee is 300 yen.

At the bottom of the display screen shown in FIG. 3, the estimated amount of the monthly usage fee corresponding to the selected vehicle model, the selected grade, and the selected option group is displayed. In FIG. 3, for example, it is assumed that the base amount for the grade is 10,000 yen, and an estimated amount of 10,300 yen including an extra fee of 300 yen resulting from selecting the option of the desired number is shown.

Furthermore, the selected grade and the selected options are reflected in the image of the vehicle in FIG. 3. Specifically, when white is selected as the exterior color, the image of the vehicle having an exterior color of white is displayed. Additionally, when options such as wheels or aero parts are selected, the displayed vehicle image will also be equipped with the selected wheels, or equipped with the selected aero parts.

When the user performs a selection operation to add an option (a touch operation on a checkbox with no checkmark displayed), the estimated amount of the monthly usage fee will be updated by being increased by the amount of the extra fee of the added option. Alternatively, when the user performs a cancellation operation to deselect an option (a touch operation on a checkbox with a check mark displayed), the estimated amount of the monthly usage fee will be updated by being reduced by the extra fee of the canceled option. Furthermore, whether an option is selected that results from addition or cancellation of the option is reflected in the image of the vehicle.

In addition, when the user performs a scroll operation in which a contact operation continues for a certain period or a certain length along the longitudinal direction (the direction parallel to the left edge or the right edge of the screen in FIG. 3 (arrow direction)) on the touch panel, hidden option items in the screen are displayed, or displayed option items are hidden.

Furthermore, when the user performs a swipe operation in which a contact operation continues for a certain period or a certain length along the horizontal direction orthogonal to the longitudinal direction (the direction parallel to the top edge or the bottom edge of the screen in FIG. 3) on the touch panel, the user can change the grade.

When the user performs a swipe operation, a first display image including the most recently selected grade, option items, and the image of the vehicle corresponding to the grade and selected options integrally slides from the center of the screen to one end, and a second display image including a grade different from the most recently selected grade, option items, and an image of the vehicle slides from the other end to the center. The entire second display image is displayed on the screen at the timing when the entire first display image moves out of the screen. Note that an example of the grade displayed before the user performs the swipe operation is a first grade, and an example of the grade displayed after the user performs the swipe operation is a second grade.

In this way, the user can select a desired vehicle by performing a grade selection operation and an option selection operation.

However, assuming that a swipe operation is performed to change only the grade with the vehicle grade and the options selected and the selected state of the options are reset to the initial state (all options are in the unselected state), the user will be asked to reselect options for the changed grade. Accordingly, the product selection operation may become troublesome.

Therefore, in the present embodiment, when the control unit 21 of the terminal 20 receives an operation for changing the vehicle grade through the input device of the touch panel display 22 with the vehicle grade and the options selected, the display of the price information is updated to that corresponding to the changed grade with the selected options maintained.

In this way, even after the operation for changing the vehicle grade is performed, the selected state of the options is maintained. Therefore, the user does not have to reselect the options and can check the price for the grade after change using the display of the updated price information. Therefore, the vehicle selection operation can be facilitated.

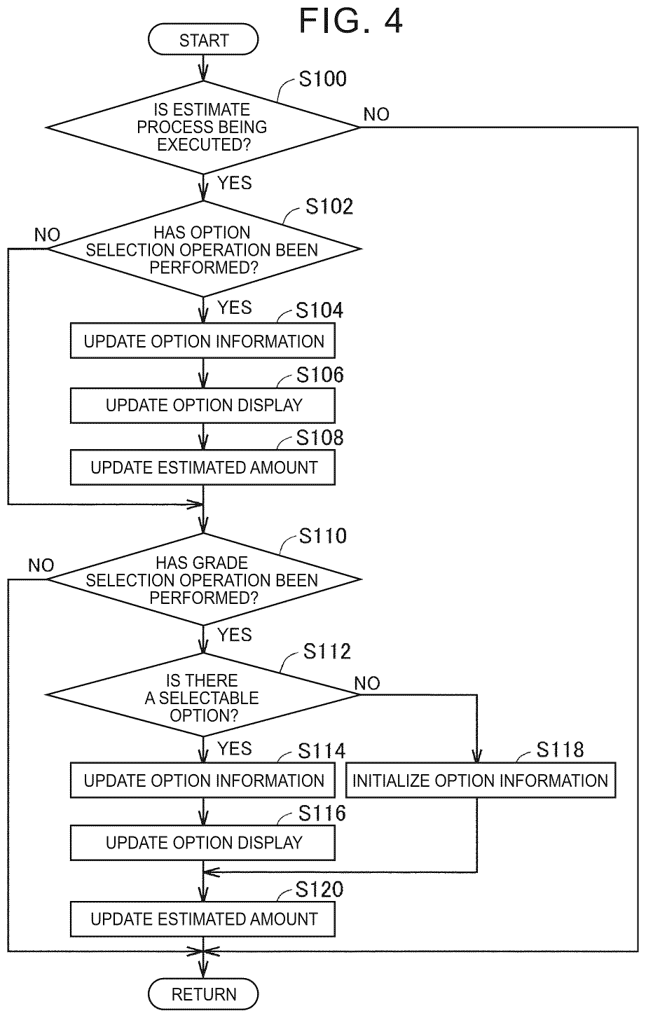

An example of the process executed by the control unit 21 will be described below with reference to FIG. 4. FIG. 4 is a flowchart illustrating an example of the process executed by the control unit 21 of the terminal 20. A series of processes shown in this flowchart is repeatedly executed at a predetermined cycle.

In step (hereinafter referred to as S) 100, the control unit 21 determines whether an estimation process is being executed. For example, when the application that displays an estimate screen is running, when the user performs an operation for starting the application, when a flag indicating that the estimation process is being executed is in an on state, or when the display screen shown in FIG. 3 is being displayed, the control unit 21 determines that the estimation process is being executed. When it is determined that the estimation process is being executed (YES in S100), the process moves to S102.

In S102, the control unit 21 determines whether an option selection operation has been performed. Specifically, the control unit 21 determines that an option selection operation has been performed when a touch operation is performed at a position corresponding to the checkbox for each option item on the display screen. Note that, for example, when the control unit 21 does not receive any option selection operation until a predetermined period has elapsed, the control unit 21 determines that no option selection operation has been performed. When it is determined that an option selection operation has been performed (YES in S102), the process moves to S104.

In S104, the control unit 21 updates option information. Specifically, the control unit 21 updates the option information by changing the state of the selected option from the unselected state to the selected state (setting a flag indicating the selection state from an off state to an on state). Subsequently, the process moves to S106.

In S106, the control unit 21 updates an option display. Specifically, the control unit 21 displays a check mark in the checkbox corresponding to the selected option, and changes the image of the vehicle to an image reflecting the selected option. Note that when an option unrelated to the appearance of the vehicle is selected or when the appearance does not change even after the selected option is reflected, the image of the vehicle is not changed. Subsequently, the process moves to S108.

In S108, the control unit 21 updates the estimated amount of the monthly usage fee. The control unit 21 calculates the total amount of the extra fee using the option information. The control unit 21 sets the fee calculated by adding the total amount of the extra fee to the preset base amount corresponding to the grade as the estimated amount of the updated monthly usage fee. The control unit 21 updates the estimated amount by changing the estimated amount to the set estimated amount. Subsequently, the process moves to S110. Note that even when it is determined that no option selection operation has been performed (NO in S102), the process moves to S110.

In S110, the control unit 21 determines whether a grade selection operation has been performed. Specifically, the control unit 21 determines that a grade selection operation has been performed when it is determined that a swipe operation has been performed on the input device of the touch panel display 22. When it is determined that a grade selection operation has been performed, the process moves to S112. Note that an example of the grade selection operation includes an operation for changing the first grade to the second grade.

In S112, the control unit 21 determines whether there is a selectable option. The control unit 21 acquires information about selectable options corresponding to the grade after change from the storage unit 24. For example, the control unit 21 determines that there is a selectable option when there is an option that matches the selectable option corresponding to the grade after change among one or more options selected for the grade before change. When it is determined that there is a selectable option (YES in S112), the process moves to S114.

At S114, the control unit 21 updates the option information. Specifically, the control unit 21 maintains, among the options selected for the grade before change, the selected state of the option that matches the selectable option corresponding to the grade after change (the flag indicating the selection state is maintained to be in the on state). Note that the control unit 21 changes, among the options selected for the grade before change, the selection state of the option that does not match the selectable option corresponding to the grade after change to the unselected state (the flag indicating the selection state is set to the off state). Subsequently, the process moves to S116.

In S116, the control unit 21 updates the option display. Since the method for updating the option display is as described above, detailed explanation thereof will not be repeated. Subsequently, the process moves to S120. Note that when it is determined that there is no selectable option (NO in S112), the process moves to S118.

In S118, the control unit 21 initializes the option information. Specifically, the control unit 21 sets the selection state of all options for the grade after change to the unselected state (that is, all flags indicating the selection state is set to the off state). Subsequently, the process moves to S120.

In S120, the control unit 21 updates the estimated amount of the monthly usage fee. Since the method for updating the estimated amount is the same as the method for updating the estimated amount in the process of S108 described above, the detailed explanation thereof will not be repeated. The process is then terminated. Note that when it is determined that no grade selection operation has been performed (NO in S110), this process then is terminated.

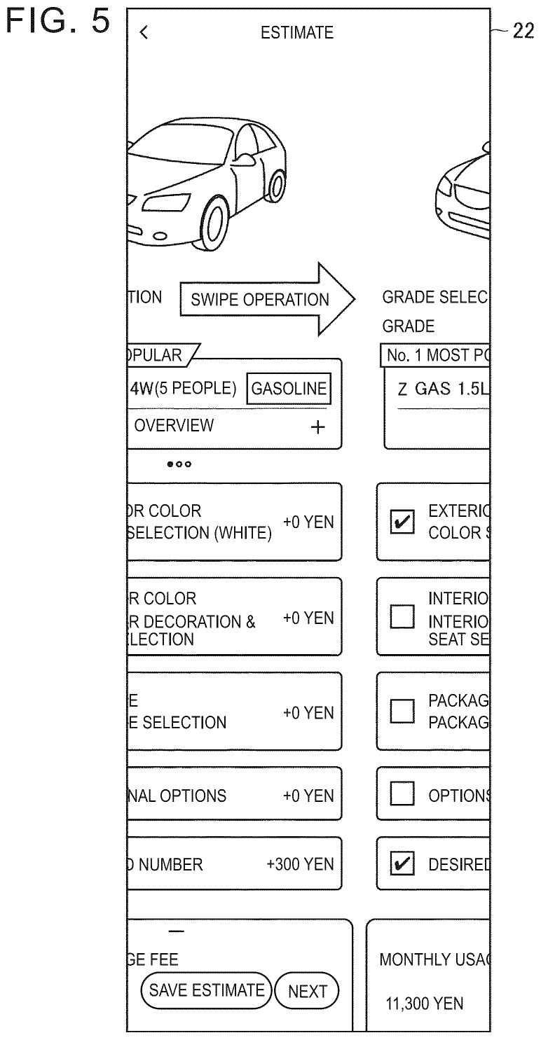

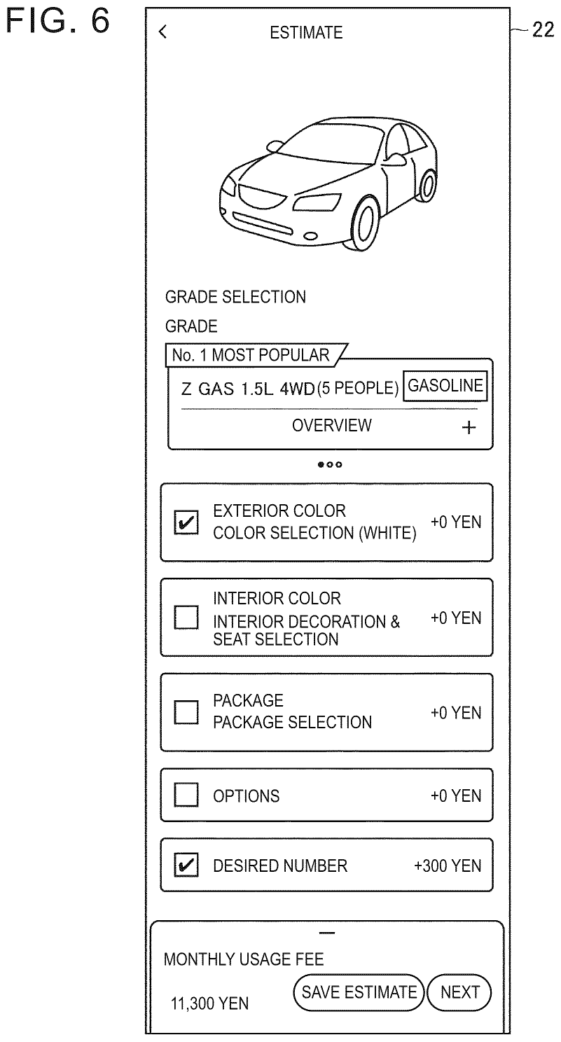

An example of the operation of the terminal 20 based on the above structure and flowchart will be described with reference to FIGS. 3, 5, and 6. FIG. 5 is a diagram for explaining an example of a change in the display screen when a swipe operation is performed. FIG. 6 is a diagram illustrating an example of the display screen displaying the estimated amount of the monthly usage fee after the grade has been changed.

For example, as shown in FIG. 3, a case is assumed in which “X” is selected as the grade. During the execution of the estimation process (YES in S100), when a selection operation is performed to select an exterior color of white as an option and a selection operation is performed to select the option for acquiring a desired number (YES in S102), the option information is updated (S104), and the option display is updated (S106). Accordingly, a check mark will be displayed in each of the checkbox of the option item corresponding to the exterior color and the checkbox of the option item corresponding to the desired number, and the selected options will be reflected in the image of the vehicle of the grade “X” on the display screen. The estimated amount then is updated (S108), so that the amount (10,300 yen) obtained by adding up the base amount (10,000 yen) corresponding to the grade “X” and the extra fee (+300 yen) corresponding to the option will be displayed as the estimated amount of the monthly usage fee.

When the user performs a swipe operation on the terminal 20, it is determined that a grade selection operation has been performed (YES in S110). At this time, as shown in FIG. 5, when a swipe operation is performed on the input device, a display image including the image of the vehicle of grade “X”, the grade information, and the option information moves from the center toward the right end side of the screen, and the display area decreases as the display image moves. When the swipe operation is performed, also a display image including the image of the vehicle of grade “Z”, the grade information, and the option information moves from the left end side to the center of the screen, and the display area increases as the display image moves. Finally, as shown in FIG. 6, only the display image including the image of the vehicle of grade “Z”, the grade information, and the option information is displayed on the screen. While the display image is being switched, when the options selected for grade “X” are selectable options (YES in S112), the option information for grade “Z” is updated (S114). That is, when the option for selecting white as the exterior color and the option for acquiring the desired number are selectable options for grade “Z”, the selected state of each of the options is maintained. The option display then is updated (S116). Accordingly, the check mark is maintained in each of the checkbox of the option item corresponding to the exterior color and the checkbox of the option item corresponding to the desired number, so that the selected options are reflected in the image of the vehicle of grade “Z” in the display screen. The estimated amount then is updated (S120), so that the amount (11,300 yen) obtained by adding up the base amount (11,000 yen) corresponding to the grade “Z” and the extra fee (+300 yen) corresponding to the option will be displayed as the estimated amount of the monthly usage fee.

As described above, with the terminal 20 according to the present embodiment, even after the operation of changing the vehicle grade is performed, the selected state of the options is maintained. Therefore, the user does not have to reselect the options and can check the price for the changed grade using the display of the updated price information. Therefore, the vehicle selection operation can be facilitated. Accordingly, it is possible to provide a terminal, a display system, and a display method that facilitate the selection operation of products.

Furthermore, when an operation for changing the grade is received, the image of the vehicle is updated to reflect the grade after change while maintaining the selected state of the options. Therefore, the user can check the appearance of the vehicle of the grade after change on the display screen of the terminal 20.

Furthermore, since the grade is changed while the display of the options including the selected exterior color is maintained, the user can easily check the appearance and the price information of the vehicle of the grade after change.

Furthermore, the grade can be selected by a swipe operation on the touch panel, and the options can be selected by a scroll operation on the touch panel. Therefore, the user can select the grade of the vehicle and the options with an easy operation.

Hereinafter, modifications will be described.

The above embodiment describes that the vehicle to be used that corresponds to the grade and options selected by selection operations on the terminal 20 is easily selectable. However, the terminal 20 is not limited to, for example, a mobile terminal, but may be, for example, a terminal such as a personal computer (PC) equipped with a touch panel display.

Furthermore, the above embodiment describes that the storage unit 24 of the terminal 20 stores information about the base amount for each grade and the extra fee for each option. However, the information may be synchronized with the management server 30 that stores the latest information each time a predetermined period of time elapses, or may be synchronized with the management server 30 when the option information is updated.

Furthermore, the above embodiment describes that the terminal 20 calculates the fee. However, the terminal 20 may transmit information about the selected options and the selected grade to the management server 30, the management server 30 may calculate the estimated amount of the monthly usage fee, and information about the estimated amount may be transmitted from the management server 30 to the terminal 20.

Furthermore, the above embodiment describes the case as an example in which the monthly usage fee is calculated when the vehicle is used under a subscription system. However, the estimated amount of the purchase amount when the vehicle is purchased may be calculated, the estimated amount of the lease fee when the vehicle is leased may be calculated, or the estimated amount of the rental fee when the vehicle is used as a rental car may be calculated.

Furthermore, the above embodiment describes the case as an example in which the grade and options of the vehicle are selected. However, the case in which the grade and options of a product other than a vehicle are selected may also be applicable. The product may be any product that can be purchased or for which a usage contract can be entered into when, for example, renting the product, using the terminal 20. For example, the product may be movable property such as home appliances, real estate such as a house, or services such as accommodation facilities.

Furthermore, the above embodiment describes the case as an example in which the monthly usage fee is calculated on the application installed on the terminal 20. However, the terminal 20 may connect to a website set on the management server 30, and the monthly usage fee may be calculated on the web browser displayed on the terminal 20.

In addition, the above modifications may be carried out by appropriately combining all or a part thereof.

The embodiment disclosed herein should be considered to be exemplary and not restrictive in all respects. The scope of the present disclosure is shown by the scope of claims rather than the description above, and is intended to include all modifications within the meaning and the scope equivalent to the scope of claims.

What is claimed is:

1. A terminal comprising:
a display device configured to display a grade of a product and an option of the product;
an input device configured to receive an operation for selecting the grade and an operation for selecting the option; and
a control device configured to control the display device to display price information of the product in a state in which the grade and the option are selected, wherein:
the grade includes a first grade and a second grade; and
the control device is configured to, in a state in which the first grade and the option are selected, when the input device receives an operation for changing grade selection from the first grade to the second grade, update a display of the price information to a display of the price information corresponding to the second grade while maintaining a selected state of the option selected in the first grade.

2. The terminal according to claim 1, wherein the control device is configured to, when the input device receives the operation for changing the grade selection from the first grade to the second grade, maintain the selected state of the option that is selectable in the second grade out of the options selected in the first grade.

3. The terminal according to claim 1, wherein the control device is configured to:
in the state in which the first grade and the option are selected, display an image of the product corresponding to the selected first grade and the selected option on the display device; and
when the input device receives the operation for changing the grade selection from the first grade to the second grade, update the image of the product corresponding to the first grade and the selected option to an image of the product corresponding to the second grade and the selected option.

4. The terminal according to claim 1, wherein the option includes at least one of an exterior color of the product, a function that is selectably provided in the product, and a function group that is a combination of a plurality of kinds of functions.

5. The terminal according to claim 1, wherein:
the input device includes a touch panel; and
the control device is configured to select the grade by receiving a contact operation in a first direction on the touch panel, and display at least one of a plurality of the options by receiving a contact operation in a second direction orthogonal to the first direction on the touch panel.

6. The terminal according to claim 1, wherein information included in the grade of the product is at least one of a fuel type, a capacity, a drive system, a displacement, and a popularity level.

7. The terminal according to claim 1, wherein the product includes a vehicle.

8. A display system comprising:
a server; and
a terminal configured to communicate with the server, wherein:
the terminal includes
a display device configured to display a grade of a product and an option of the product, an input device configured to receive an operation for selecting the grade and an operation for selecting the option, and
a control device configured to control the display device to display price information of the product in a state in which the grade and the option are selected;
the grade includes a first grade and a second grade; and
the control device is configured to, in a state in which the first grade and the option are selected, when the input device receives an operation for changing grade selection from the first grade to the second grade, generate the price information corresponding to the second grade using information received from the server and update a display of the price information to a display of the generated price information while maintaining a selected state of the option selected in the first grade.

9. A display method that displays price information of a product on a display by a control device, the display method executed by the control device comprising:
receiving an operation for selecting a grade of the product and an operation for selecting an option of the product;
displaying on the display the price information of the product in a state in which the grade and the option are selected, wherein the grade includes a first grade and a second grade;
and, in a state in which the first grade and the option are selected, when an operation for changing grade selection from the first grade to the second grade is received, updating a display of the price information to a display of the price information corresponding to the second grade while maintaining a selected state of the option selected in the first grade.
